(19) United States
(12) Patent Application Publication
(10) Pub. No.: US 2013/0089338 A1
(43) Pub. Date: Apr. 11, 2013

(54) COMMUNICATION NETWORK

(71) Applicant: Hugo Silberman, Kfar Sirkin (IL)

(72) Inventor: Hugo Silberman, Kfar Sirkin (IL)

(73) Assignee: RAD DATA COMMUNICATIONS LTD., Tel Aviv (IL)

(21) Appl. No.: 13/269,967

(22) Filed: Oct. 10, 2011

(51) Int. Cl. H04B 10/12

(52) U.S. Cl. 398/141

(57) ABSTRACT

An optical access network that connects customers to a core network, the access network comprising: a different Optical Network Unit (ONU) connected to each customer; a different head-end device for each ONU that receives data from the core network intended for the ONU and configures the data for transmission to the ONU in accordance with a passive optical network (PON) protocol; and an optical fiber that connects the head-end device to the ONU.

### TECHNICAL FIELD

Embodiments of the invention relate to communication networks.

### BACKGROUND

Modern communication networks that provide residential and business customers with voice, video, and/or data communication services typically comprise various types of equipment that generate, transmit, and receive communication signals that carry data implementing the services. The signals may comprise optical signals transmitted over optical fibers, electric signals transmitted over copper cables, and radio (wireless) signals transmitted in free space. Hereinafter, voice, video, and data information transmitted by a communication network is referred to generically as “data”.

Communication networks can be generally decomposed into a core network connected to a plurality of access networks, each of which connects customer premises equipment (CPEs) at sites of residential or business customers of the network to the core network. The core network functions to connect the access networks to each other and to data centers, and is configured to transport sufficiently, and generally, very large amounts of data to support communication traffic to and from the access networks. Core networks are logically organized as mesh topologies in which communication devices comprised in the network are richly interconnected and provide multiple communication paths between some or all of the communication devices.

Access networks handle smaller amounts of data, and are often organized in a tree topology. A graphical representation of communication devices and communication channels that connect the devices in a network logically organized in a tree topology is reminiscent of branching of a tree. Typically, a first device in the network is directly connected by communication channels to at least two second devices. Each of the second devices in turn is directly connected by communication channels to at least two other third devices, but not to other second devices. Similarly, each of the third devices may in turn be directly connected to a plurality of fourth devices but are not directly connected to the first device or to any of the other third devices. The cascade of devices and direct communication channels, graphically represented by points and lines respectively, resembles the branching of a tree.

Access networks organized in tree topologies can be classified as being active or passive. In an active network, branching points are active devices such as Ethernet switches or internet protocol (IP) routers. When such an active device receives a data packet from the core destined for a particular CPE, it examines the packet header and actively chooses an appropriate link over which to forward the data packet in order for it to reach the particular CPE. The active access network operates to dynamically establish a dedicated point-to-point communication channel between the core network and the particular CPE. Since the dedicated channel carries only packets addressed to the particular CPE, the channel provides the CPE, and the source of the packets, with a relatively high degree of confidentiality for data transmission between the core and the CPE.

In a passive network, the branching points are passive devices, such as optical splitters. Communication traffic from the core is blindly replicated to all downward links, and thus all data packets from the core arrive at all CPEs. Each given CPE recognizes data packets that reach it and are addressed to it, and ignores all data packets that reach it that are addressed to other CPEs. The passive access network operates as a point-to-multipoint network in which the passive components of the network provide communication channels over which data packets transmitted by the core network are broadcast to all CPEs connected to the access network. Because all the CPEs connected to the access network receive all the data packets transmitted by the core network, transmission confidentially is inherently relatively weak, and acceptable degrees of confidentiality may be provided by encryption. Upstream transmissions by CPEs intended for the core are controlled in accordance with a time division multiple access (TDMA) protocol.

Passive networks have become popular for optical access networks. Passive optical access networks, typically referred to by an acronym comprising “PON”, comprise an Optical Line Terminal (OLT), directly connected to a core network, and a plurality of Optical Network Units (ONUs) connected to the OLT by a tree configuration of passive optical splitters and optical fiber links. Each ONU connects a customer to the PON and thereby to the core network, and may serve as customer premise equipment or be connected to customer premise equipment, such as a router, wireless access point, workstation, or server. The OLT receives data from the core network for the customers connected to the PON and broadcasts all the data downstream to all the PONs. Each PON selects only data addressed for the customer to which it is connected and ignores the other data. Communications from the customers are transmitted by their respective ONUs upstream to the OLT in accordance with a TDMA protocol administered by the OLT.

Several different PON protocols have been standardized. Among them are Broadband Passive Optical Network (BPON), Gigabit Passive Optical Network (GPON), and Ethernet Passive Optical Network (EPON). All of these comprise an OLT and ONUs, and employ the same fundamental principle of downstream broadcast and upstream TDMA, but differ in data transmission rates, encapsulation format, and control protocol details.

Despite the fact that an ONU needs to support the PON control protocol, protocol-specific encapsulations, and perhaps data decryption, ONUs tend to be significantly less expensive than CPEs employed in active access networks.

### SUMMARY

An embodiment of the invention relates to providing an optical access network that uses passive access network optical components configured in a tree topology to provide customers with point-to-point, high confidentiality connections to a core network. An access network in accordance with an embodiment of the invention each customer is connected to an ONU that is connected by its own optical fiber to a head-end device connected to the core network. In an embodiment of the invention, the head-end device comprises an OLT. Optionally, the head-end device implements OLT functionality and formats data that it receives for the customer from the core network into PON frames configured for reception by the customer's PON.

In the discussion, unless otherwise stated, adjectives such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical structures, elements or parts that appear in more than one figure are generally labeled with a same numeral in all the figures in which they appear. Dimensions of components and features shown in the figures are chosen for convenience and clarity of presentation and are not necessarily shown to scale.

FIG. 1 schematically shows a tree topology access network delivering data it receives from a core network to customers, in accordance with prior art;

FIG. 2 schematically shows a passive optical network (PON) delivering data it receives from a core network to customers, in accordance with prior art; and

FIG. 3 schematically shows a tree topology access network delivering data it receives from a core network to customers, in accordance with an embodiment of the invention.

### DETAILED DESCRIPTION

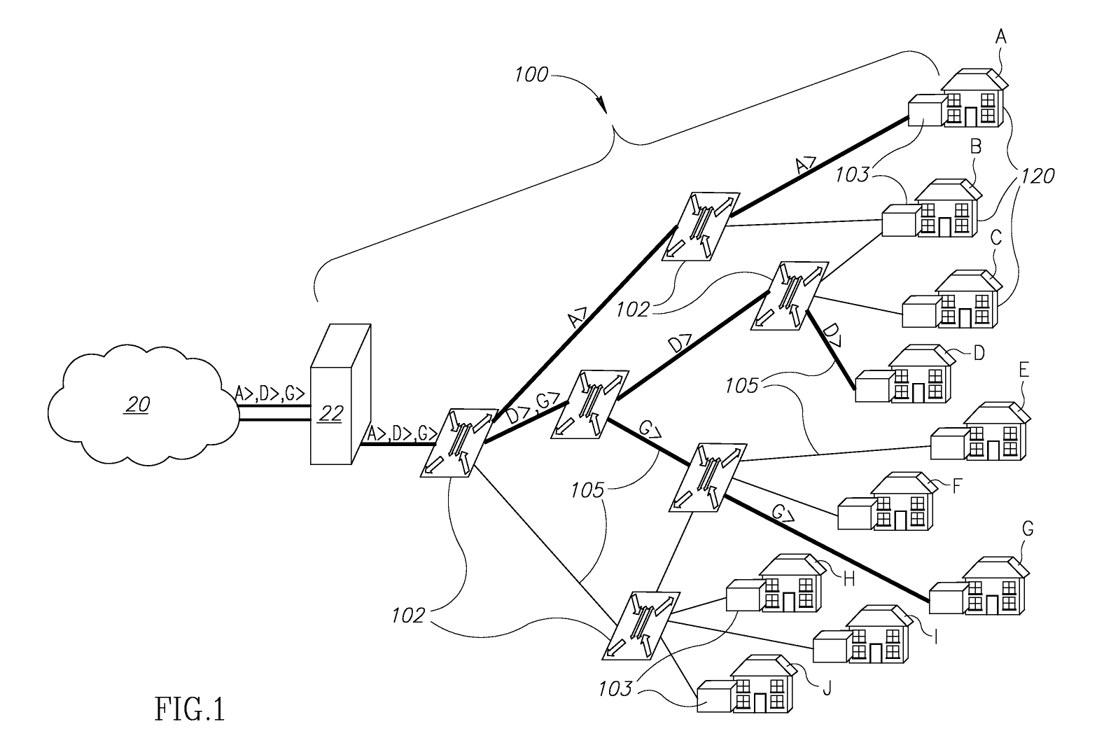

FIG. 1 schematically shows an active optical access network 100 coupling a plurality of customers 120, individually referenced by letters A, B, C . . . J, to a core network 20 and transferring data from the core network to the customers. Access network 100 optionally comprises an edge device 22, active switches 102, and a CPE 103 for each customer 120. Data packets are transported over the access network in optical format and the edge device, switches and CPEs are connected by optical fibers 105.

Edge device 22 directs data packets from the core network intended for a customer 120 to access network 100 and directs data packets it receives from access network 100 to the core network. Being located at a demarcation point between core network 20 and access network 100, edge device 22 may be considered to belong to core network 20 as well as to access network 100. Edge device 22 is thus configured with demarcation functionality, including Operations, Administration, and Maintenance (OAM) protocols, and Quality of Service (QoS) mechanisms such as traffic shaping.

CPEs 103 forward data packets they receive from edge device 22 via access network 100 to the customer networks (not shown) and data packets that they receive from the customer networks to the access network for transport to the edge device. Edge device 22, forwards data packets it receives from the access network to the core network, or bridges them back to another customer in the same access network. Being the demarcation point between access network 100 and the customer network, a CPE may be considered to belong to access network 100 as well as to the customer network. CPEs 103 are thus configured with demarcation functionality, including OAM protocols, and QoS mechanisms such as traffic shaping.

Active switches 102 identify data packets, read header information of these data packets, and actively make decisions as to how to properly forward data packets to their intended destinations.

By way of example, in FIG. 1 edge device 22 is schematically shown forwarding data packets from core network 20 for customers A, D and G to a first active switch 102 in the access network nearest to the edge device. Data packets intended for customer A, D, or G is indicated by A>, D>, or G> respectively, where the direction of the bracket > indicates a direction of propagation of the data packet.

Upon receiving data packets A>, D>, or G> the first switch checks the destination addresses of the data packets to determine the addresses of CPEs 103 of customers for which they are respectively intended. The switch then forwards them to appropriate next switches 102 responsive to the determined addresses to advance them to their destinations. Each switch 102 in its turn, upon receiving a packet A>, D>, or G> from another switch 102 performs similarly to the first switch to check the packet address and forward the packet towards its destination. The routes determined by switches 102 along which packets A>, D>, or G> propagate to their intended customer CPEs 103 are indicated by optical fibers 105 along which the symbols A>, D>or G> are shown.

The operation of an active switch 102 in determining a destination address of an optical packet that the switch receives and then forwarding it to another switch 102 responsive to the address requires converting the optical packet to electrical signals for processing. After processing the electrical signals to determine the packets address, the switch reconverts the electrical signals to an optical signal for forwarding. To perform their tasks, switches 102 need to be provided with energy, and to maintain quality of their performance the switches have to be continuously monitored and regularly maintained. The switches and the CPEs they service are therefore relatively expensive devices from both capital expense and operational expense points of view.

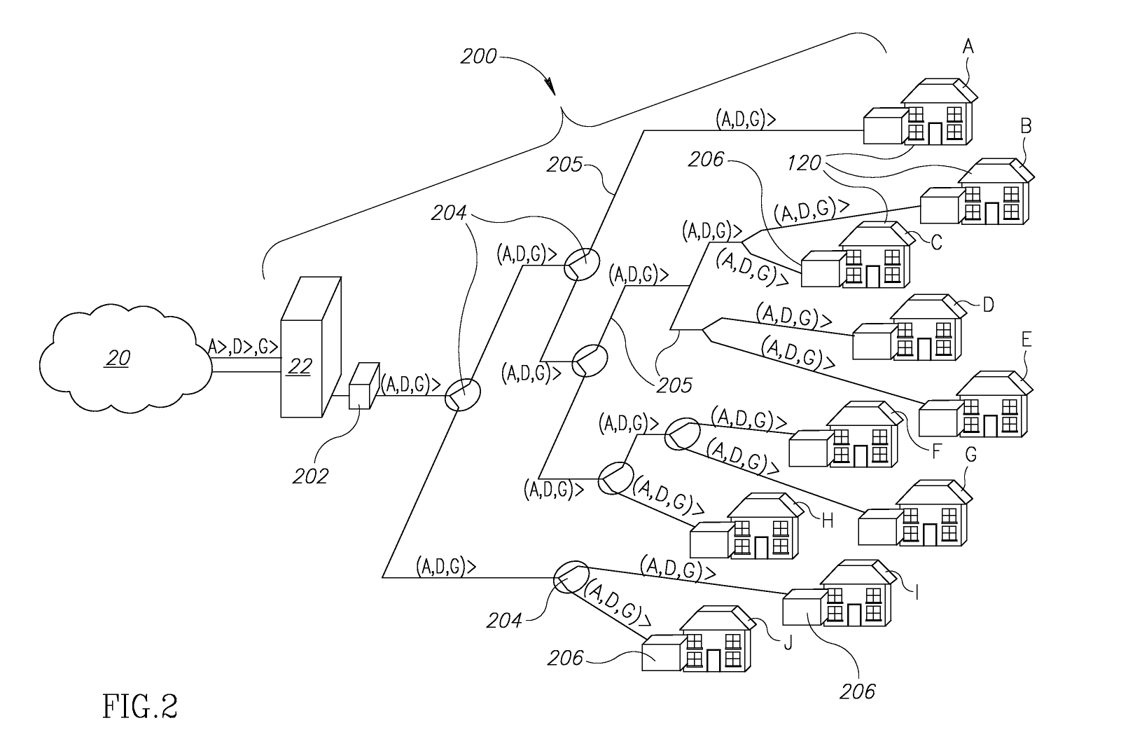

FIG. 2 schematically shows a PON 200 connecting customers 120, A-J shown in FIG. 1, to core network 20. PON 300 comprises an ONU 206 for each customer. The ONUs are connected to an OLT 202 by a tree configuration of a plurality of passive optical splitters 204 and fibers 205. By way of example, in PON 200 each ONU functions as customer premises equipment.

When OLT 202 receives data from core network 20 destined for its customers 120 it encapsulates the data in PON frames having payloads labeled with the addresses of ONUs associated with customers for whom the payloads are intended, and broadcasts all the frames to all the ONUs. Optionally, OLT 202 encrypts the data payloads to provide confidentiality of the data for each of customers 120. Each ONU 206 extracts from frames it receives data addressed to it, and ignores data in the frames addressed to other ONUs.

By way of example, in FIG. 2, OLT 202 is shown receiving data from core network 20 for customers A, D, and G. Upon receipt, the OLT encapsulates the data in a frame, represented by the letters A, D, and G embraced by parentheses, and broadcasts the frame to all ONUs 206 via optical splitters 204. Whereas all ONUs 206 receive frame (A,D,G) only ONUs 206 connected to customers A, D, and G extract data from the frame and they respectively extract only A, only D, or only G data from the frame.

As noted above, communications traffic from customers 120 to OLT 202 and therefrom to core network 20 are administered by OLT 202 in accordance with a TDMA protocol. When an ONU 206 receives data from its associated customer 120 destined for the core network, it transmits this data upstream to the OLT in a time slot granted to the ONU by the OLT in accordance with the TDMA protocol. Time slots are granted to ONUs 206 by the OLT based on demand and priority reported by the ONUs to the OLT using a control protocol. The time slots are timed and temporally separated by guard periods to avoid data from two or more ONUs arriving simultaneously at the OLT, taking into account differing distances and thus propagation latencies. The latencies are measured by the control protocol using a process known as “ranging”. Since OLT 202 receives optical signals from multiple ONUs at various distances, it needs to adapt to the signal strength and timing of each ONU transmission.

Whereas a PON access network does not support point-to-point communications and therefore is inherently characterized by a relatively low level of confidentiality, PON access networks are generally advantageous with respect to cost and upkeep relative to active access networks. Passive splitters used to broadcast data from a PON OLT are relatively inexpensive, low maintenance devices that do not require power since they do not perform optical-electrical-optical conversion. ONUs, used in PON networks, even though they are configured to support a PON protocols and optionally encryption schemes ONUs are also relatively inexpensive.

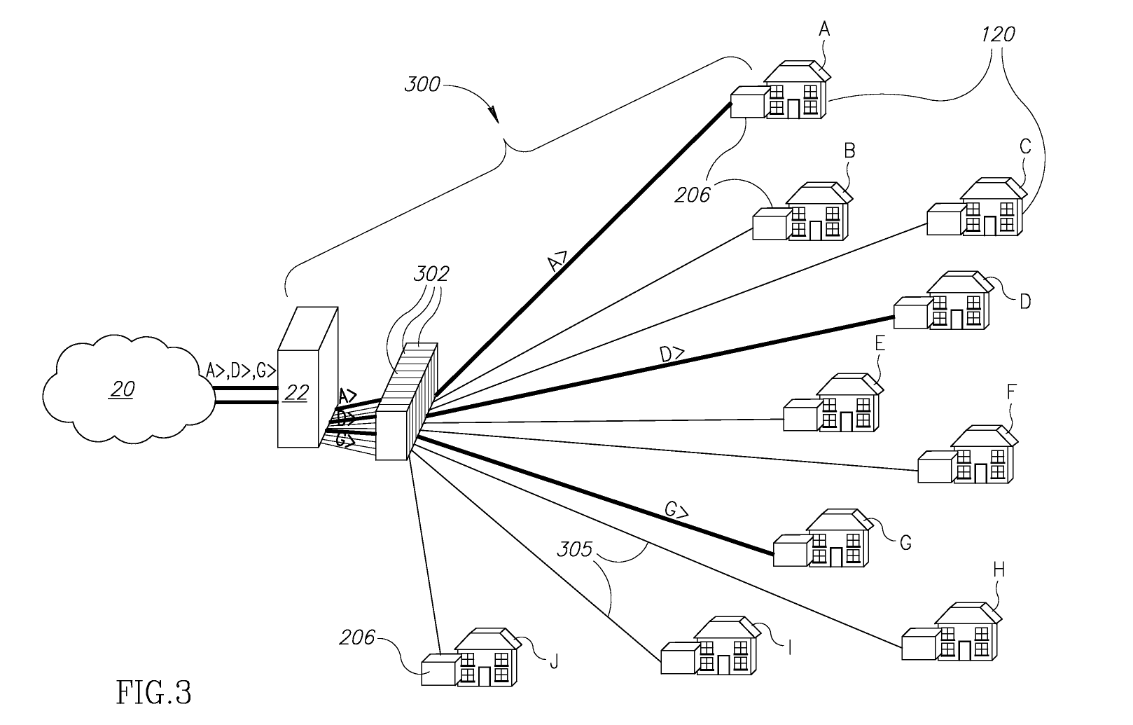

FIG. 3 schematically shows an access network 300 connecting each of customers 120 to core network 20 by dedicated point-to-point optical links, in accordance with an embodiment of the invention. To provide the point-to-point links, network 300 optionally comprises a plurality of head-end devices 302 each connected to core network 20 via edge device 22 and to a single customer 120 by a dedicated optical fiber 305 and an ONU 206. It is noted that whereas head-end devices 302 are shown in FIG. 3 housed in different housings, functionalities of the individual head-end devices may of course be housed in a same housing having appropriate ports for connecting fibers 305 from ONUs 206.

A head-end device 302 of the plurality of head-end devices may be housed in a small form factor housing. Such a small form factor housing may conform to a small form factor pluggable (SFP), enhanced small form factor pluggable (SFP+), Gigabit interface converter (GBIC), or any other similar small form factor standard. Optionally at least two such small form factor devices may be plugged into a single chassis.

Each given head-end device 302 emulates operation of an OLT in that it encapsulates data packets in PON frames, and carries out PON control protocols. However, since head-end device 302 is only connected to a single ONU, it need not provide guard periods for time slots provided to the ONU, making upstream bandwidth utilization more efficient. In addition, there is no need to adapt to different signal strengths and latencies, making head-end device 302 potentially less complex than a full OLT. The head-end device receives data from core network 20 via edge device 22 addressed to the customer ONU 206 to which it is connected by a fiber 305, and encapsulates the data it receives in a PON format. After encapsulation, the head-end device transmits the encapsulated data over fiber 305 to the customer ONU 206. Only the ONU directly connected to the given head-end device receives data from core network 20 addressed to the ONU. As a result each customer of access network 300 receives only data addressed to it and not data addressed to other customers of the access network. Thus encryption may not be required, further simplifying operations. By way of example, FIG. 3 shows edge unit 22 forwarding data from core network 20 intended for customers A, D and G to head-end devices 302 that are connected to the ONUs 206 of the respective customers. The point-to-point channels that connect customers A, D and G to edge unit 22 are shown in bold enhancement in FIG. 3.

Each head-end device 302 performs ranging to determine propagation latency associated with transmission of data to and from ONU 206 to which it is connected. In an embodiment of the invention, each head-end device 302 grants time slots for upstream transmission of data to core network 20 to the ONU to which it is connected in accordance with the conventional PON protocol responsive to requests received from the ONU. In an alternative embodiment of the invention each head-end device grants time slots for upstream transmission independent of bandwidth requests that it receives from the ONU. Optionally, the head-end device provides a default upstream channel that is always available to the ONU. Optionally, an amount of bandwidth that the head-on device makes available to the ONU is independent of ONU requests. Optionally, independent of an amount of bandwidth that may be requested by the ONU, the head-end device allocates a maximum amount of bandwidth to the ONU that the head-end device has available.

As discussed above, the head-end device may be a conventional OLT, or may be a simpler device. The head-end may be embodied in a converter that connects to a standard active switch and feeds an ONU. From the viewpoint of the switch the converter looks like an active point-to-point optical link, while to the ONU it looks like an OLT. Such a converter may advantageously be housed in an SFP that is plugged into the switch.

Access network 300 provides advantages of point-to-point communication for such as high guaranteed bandwidth and strong data security, at capital and operations similar to those of PONs.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A point-to-point optical communication channel comprising:
an Optical Network Unit (ONU);
a head-end device that receives data for the ONU and configures the data for transmission to the ONU in accordance with a passive optical network (PON) protocol; and
an optical fiber that connects the head-end device to the ONU.

2. A point-to-point optical communication channel according to claim 1 wherein the head-end device provides the ONU with time slots in accordance with a TDMA protocol for upstream transmission of data from the ONU to the head-end device.

3. A point-to-point optical communication channel according to claim 2 wherein the time slots are not separated by guard periods.

4. A point-to-point optical communication channel according to claim 2 wherein the head-end device provides the ONU with bandwidth for upstream transmission independent of requests for bandwidth that the ONU may transmit to the head-end device in accordance with the PON protocol.

5. A point-to-point optical communication channel according to claim 1 wherein the head-end device comprises an OLT.

6. A point-to-point optical communication channel according to claim 1 wherein the head-end device is housed in a small form factor housing.

7. A point-to-point optical communication channel wherein the PON protocol is a protocol chosen from the group protocols consisting of a GPON protocol and an EPON protocol.

8. An optical access network that connects a plurality of customers to a core network, the access network comprising:
a dedicated point to point optical channel according to claim 1 for each customer; and
a communication channel that connects the head-end device in each channel to the core network.

9. An optical access network according to claim 8 wherein the head-end device provides the ONU with time slots in accordance with a TDMA protocol for upstream transmission of data from the ONU to the head-end device.

10. An optical access network according to claim 9 wherein the time slots are not separated by guard periods.

11. An optical access network according to claim 9 wherein the head-end device provides the ONU with bandwidth for upstream transmission independent of requests for bandwidth that the ONU may transmit to the head-end device in accordance with the PON protocol.

12. An optical access network according to claim 1 wherein the head-end device comprises an OLT.

13. An optical access network according to claim 8 wherein the head-end device is housed in a small form factor housing.

14. An optical access network according to claim 8 wherein at least two of the head-end devices are housed in a same small form factor housing.

15. An optical access network according to claim 8 wherein the PON protocol is a protocol chosen from the group protocols consisting of a GPON protocol and an EPON protocol.

16. A method of connecting a plurality of customers to a core network, the method comprising:
providing each customer with its own ONU; and
transmitting to each ONU only data intended for the customer to which the ONU is connected.

17. A method according to claim 16 wherein transmitting to each ONU comprises connecting each ONU to a different head-end device that receives data from the core network for the customer connected to the ONU, and configures the data for transmission to the ONU in accordance with a passive optical network (PON) protocol.

18. A method according to claim 17 and transmitting data from the ONU to the head-end device in time slots configured in accordance with a TDMA protocol.

19. A method according to claim 18 wherein the time slots are not separated by guard periods.

20. A method according to claim 17 and comprising providing the ONU with bandwidth for upstream transmission independent of requests for bandwidth that the ONU may transmit in accordance with the PON protocol.

21. An optical access network according to claim 16 wherein the PON protocol is a protocol chosen from the group protocols consisting of a GPON protocol and an EPON protocol.
